(19) United States
(12) Patent Application Publication
(10) Pub. No.: US 2026/0359138 A1
(43) Pub. Date: Nov. 12, 2026

(54) SYSTEMS AND METHODS FOR DOMAIN TRANSLATION

(71) Applicant: Cerebras Systems Inc., Sunnyvale, CA (US)

(72) Inventors: Tomas Oppelstrup, Sunnyvale, CA (US); Ilya Sharapov, San Jose, CA (US); Michael Edwin James, San Carlos, CA (US)

(21) Appl. No.: 19/646,428

(22) Filed: Apr. 13, 2026

Related U.S. Application Data
(60) Provisional application No. 63/788,784, filed on Apr. 14, 2025.

(51) Int. Cl. G06F 9/50; H04L 41/0803

(52) U.S. Cl. CPC G06F 9/5072; H04L 41/0803

(57) ABSTRACT

The present disclosure describes systems and methods for network latency management for a plurality of devices for performing computations, each device of the plurality of devices comprising a respective arrangement of processing elements (PEs). A method includes mapping a model to the plurality of devices, wherein mapping the model comprises defining a translation vector of at least two dimensions, wherein each component of the translation vector is a nonzero value, and wherein the plurality of devices is configured to perform one or more computations using a first set of PEs of the plurality of devices based on the model to generate respective values and unidirectionally transmit the values to a respective second set of PEs for performing subsequent computations, wherein the respective second set of PEs is located in a direction along the translation vector.

### CROSS-REFERENCE TO RELATED APPLICATIONS

This application claims the benefit of U.S. Provisional Patent Application No. 63/788,784, filed Apr. 14, 2025, which is incorporated by reference herein in its entirety.

### TECHNICAL FIELD

The present disclosure relates to latency management in high-performance computing (HPC) including translating a mapping of computations on one or more large-chip devices.

### SUMMARY

In high-performance computing (HPC), cluster computing techniques including parallelizing computations using a plurality of devices (e.g., servers, processors, compute nodes, etc.) is often applied to accelerate applications such as physical phenomena modeling and/or machine learning modeling (e.g., neural networks, artificial intelligence (AI) agents). For example, domain decomposition techniques may include partitioning a computational model and mapping the partitions and associated computations to a plurality of devices. For example, the respective computations may be performed using the plurality of devices, each device generating respective values and/or transmitting the values.

In some approaches, cluster implementations of distributed computations may be limited by network latency between devices. For example, the network latency may impose an upper bound on iterative and/or time-marching calculations based on the network bandwidth and/or network latency. The network bottleneck limits the strong scaling of processing workloads and may prevent acceptable performance for some applications without large expenditure of time and compute resources due to the bottleneck. As an illustrative example, performing computations and communicating the output data between the devices additively contribute the network latency from each communication to the process time, increasing the overall time-to-result (TTR) and slowing down the application.

Accordingly, there is a need for HPC techniques that reduce the effect on compute time of the internode latency between compute clusters, enabling strong scaling of the processing workloads.

To address the aforementioned issues and more, the present disclosure describes one or more embodiments including a plurality of devices (e.g., as compute nodes), each device including a respective arrangement of processing elements (PEs), wherein a model is mapped to the plurality of devices such that the plurality of devices performs respective computations and transmit the output data to respective PEs located along a defined translation vector. In some embodiments, each device includes respective PEs arranged based on parallel, spatial, and/or data-flow compute architectures. For example, the PEs may be arranged in a grid and/or locally connected with a network-on-chip (NOC) router.

In some embodiments, a method is described for configuring a plurality of devices for performing computations, each device of the plurality of devices comprising a respective arrangement of PEs. The method includes mapping a model to the plurality of devices, wherein mapping the model comprises defining a translation vector of at least two dimensions, wherein each component of the translation vector is a nonzero value, and wherein the plurality of devices is configured to perform one or more computations using a first set of PEs of the plurality of devices based on the model to generate respective values and unidirectionally transmit the values to a respective second set of PEs for performing subsequent computations, wherein the respective second set of PEs is located in a direction along the translation vector.

In some embodiments, the first set of PEs may overlap with the second set of PEs. For example, one or more PEs of the first set may be included in the second set of PEs. In some embodiments, the first set of PEs may be the same as the second set of PEs. For example, data may be transmitted using one or more wrap-around communications at a device boundary (e.g., using one or more loop connections by one or more PEs at the device boundary) such that the data returns to the same device (e.g., to the set of PEs of the device).

As an illustrative example, a computational model may include a domain (e.g., an area or volume) that is partitioned into a plurality of subdomains (e.g., a grid). Computations (e.g., stencil-based computations for a grid) associated with each subdomain may be assigned to respective compute nodes and performed concurrently. In this example, PEs (e.g., processors, processing cores, other suitable processing circuitry, etc.) may be arranged to correspond with the subdomains such that the PEs are located at grid points of a grid. One or more first PEs of a first compute node may be located at a node boundary (e.g., a subdomain boundary) and communicate with one or more second PEs at a second compute node across the node boundary. For example, the nodes may be coupled using network links (e.g., network switches, routers, another suitable interface, etc.), and the first PEs may transmit data to the second PEs using the network links. The network links may incur network latency (e.g., based on the slowest network link) for each communication. If the network links are bi-directional, PEs near to the node boundary may exchange data, incurring the latency by each communication. The compute nodes may be configured such that the data is unidirectionally transmitted along a translation vector of at least two dimensions. In this example with a grid arrangement, a 2-D translation vector may be one grid point in each of the horizontal and vertical directions. It is noted that a translation vector is not limited to two dimensions and that a translation vector as described herein may include any number of dimensions of nonzero value. A plurality of PEs may concurrently perform assigned computations and generate respective data. The respective data may be transmitted towards respective destination PEs located in a direction along the translation vector in one or more phases. For example, the respective data may be transmitted from a first PE to a horizontally-adjacent second PE and then from the second PE to a third PE that is vertically adjacent to the second PE. As a second, non-limiting example, the data may be transmitted from a first PE to a vertically-adjacent second PE and then from the second PE to a third PE that is horizontally adjacent to the second PE.

In some embodiments, the computations and/or transmission of data are arranged such that the sequence occurs during one or more time steps. For example, the sequence may be completed within a time step. In some embodiments, data, or portions thereof, may be transmitted towards a same destination PE along different routes. For example, a second PE may be located diagonally away from a first PE (e.g., one or more respective grid points in each of the horizontal and vertical directions). A first portion of the data may be transmitted along a first route (e.g., horizontally from the first PE to a horizontally-adjacent PE and then vertically to the next PE, etc.,) to reach the second PE. A second portion of the data may be transmitted along a second route (e.g., from the first PE to a vertically-adjacent PE and then horizontally to the next PE, etc.) to reach the second PE. The respective portions of data may be concurrently transmitted along their respective routes and/or reach the destination PE at about the same time. In some embodiments, one or more intervening PEs along the respective routes may perform computations based on the received data and/or generate interim data, or portion thereof, that is transmitted to the next PE. In some embodiments, intervening PEs along the respective routes transmit the data and do not perform computations based on the received data. In some embodiments, the sequence of computations and data communications may be arranged to occur in one or more time steps. For example, the data may be transmitted from the first PE to second PE within a time step. For example, a counter (e.g., to indicate time step and/or iteration) may be incremented after the sequence is completed.

In some aspects, the nodes are configured such that data flow is unidirectional across the node boundary, avoiding buildup of network latency contributions. In some aspects, mapping the model such that the data flow is unidirectional enables maintaining high cluster efficiency for distributed computing with fine-grain parallelism. In some aspects, the impact of network latency is amortized over the width of the device substrate. In some aspects, mapping the model such that the data flow is unidirectional delivers compute performance weak-and strong-scaling, enabling large-scale applications that may be prohibitively costly in time and compute resources with some other approaches. In some aspects, mapping the model as described herein enables one or more compute clusters to perform the computations as a unit, even if the clusters may be remote to each other (e.g., in different cities).

In some aspects, the present disclosure describes one or more embodiments suitable for computing a stencil code efficiently over high-latency network links. In some embodiments, a plurality of compute nodes may be arranged and connected in a ring (e.g., torus).

In some embodiments, the method may include performing the computations using the plurality of devices based on the mapping. In some embodiments, mapping the model includes translating the mapping of computations to PEs by one or more units (e.g., one or more grid points) along the translation vector after each iteration. In some embodiments, the values are transmitted to a second set of PEs that is positioned one or more units along the translation vector from the first set of PEs.

In some embodiments, one or both of the first set of PEs and the second set of PEs include one or more first PEs of a first device of the plurality of devices and one or more second PEs of a second device of the plurality of devices.

In some embodiments, the plurality of devices may be configured such that each PE of the first set of PEs transmits the respective values using one or more respective communication ports associated with the direction, and such that each PE of the second set of PEs receives the respective values using one or more respective communication ports associated with the direction.

In some embodiments, the plurality of devices may be configured such that the values are transmitted along a first component of the translation vector, and wherein the values are transmitted along a second component of the translation vector.

In some embodiments, mapping the model may include defining a plurality of subdomains based on a computational grid, wherein the one or more computations are associated with a respective subdomain of the plurality of subdomains.

In some embodiments, the model may include a neural network model, wherein the neural network model includes a plurality of nodes. The plurality of devices may be configured such that the values are unidirectionally transmitted to the respective second set of PEs mapped to respective nodes of the plurality of nodes.

In some embodiments, the first set of PEs may be associated with a first device of the plurality of devices, and the first device may be coupled to one or more second devices using one or more network links. The first device may be configured to unidirectionally transmit the respective values using the one or more network links.

In some embodiments, the method may include remapping the model to the plurality of devices, wherein respective operations associated with at least one first PE of the first set of PEs are remapped to at least one second PE of the respective second set of PEs located in the direction along the translation vector.

In some embodiments, the plurality of devices may include one or more large-chip devices, and wherein each large-chip device of the one or more large-chip devices comprises a respective plurality of PEs arranged on a respective substrate of the large-chip device.

In some embodiments, a system is described. The system includes a plurality of devices, each device of the plurality of devices comprising a respective arrangement of processing elements (PEs), and processing circuitry. The processing circuitry is configured to map a model to the plurality of devices, wherein the processing circuitry, when mapping the model to the plurality of devices, is configured to define a translation vector of at least two dimensions, wherein each component of the translation vector is a nonzero value, and the plurality of devices is configured to perform one or more computations using a first set of PEs of the plurality of devices based on the model to generate respective values and unidirectionally transmit the values to a respective second set of PEs for performing subsequent computations, wherein the respective second set of PEs is located in a direction along the translation vector.

In some embodiments, a computer-readable medium (CRM) is described. The CRM may include one or more instructions that, when executed by control circuitry, cause the control circuitry to map a model to a plurality of devices for performing computations, each device of the plurality of devices comprising a respective arrangement of PEs, wherein the one or more instructions cause the control circuitry to define a translation vector of at least two dimensions, wherein each component of the translation vector is a nonzero value, and wherein the plurality of devices is configured to perform one or more computations using a first set of PEs of the plurality of devices based on the model to generate respective values and unidirectionally transmit the values to a respective second set of PEs for performing subsequent computations, wherein the respective second set of PEs is located in a direction along the translation vector.

### BRIEF DESCRIPTION OF THE DRAWINGS

The following description includes description of figures having illustrations given by way of example of implementations of embodiments of the disclosure. The drawings should be understood by way of example, and not by way of limitation. As used herein, references to one or more “embodiments” are to be understood as describing a particular feature, structure, and/or characteristic included in at least one implementation. Thus, phrases such as “in some embodiments” appearing herein describe various embodiments and implementations, and do not necessarily all refer to the same one or more embodiment. However, they are also not necessarily mutually exclusive. It should be noted that for clarity and ease of illustration, these drawings are not necessarily made to scale. In the drawings:

FIGS. 1A-1B depict some example scenarios in which a domain and/or a model are mapped to a plurality of compute nodes, in accordance with some embodiments of this disclosure;

FIG. 2 depicts an example system including unidirectionally transmitting data for respective PEs of a plurality of devices along a direction of translation, in accordance with some embodiments of this disclosure;

FIG. 3 depicts a data flow diagram of an example system including a plurality of devices having data transmitted along a direction of translation, in accordance with some embodiments of this disclosure;

FIG. 4 depicts an example compute grid with reduced network latency between compute nodes, in accordance with some embodiments of this disclosure;

FIG. 5 depicts an example system with data unidirectionally flowing along a direction of translation, in accordance with some embodiments of this disclosure;

FIG. 6 depicts an example system with data flow over one or more computation steps between compute nodes, in accordance with some embodiments of this disclosure;

FIG. 7 depicts an example compute accelerator including a plurality of PEs coupled to an interface, in accordance with some embodiments of this disclosure;

FIG. 8 depicts an example configuration of a compute accelerator including a plurality of PEs disposed at a single substrate, in accordance with some embodiments of this disclosure;

FIG. 9 depicts a block diagram illustrating an example processing element and some components thereof, in accordance with some embodiments of this disclosure;

FIG. 10 depicts an example cluster including a plurality of compute accelerators coupled together using one or more network links, in accordance with some embodiments of this disclosure;

FIG. 11 depicts an example data flow of a compute accelerator using one or more communication channels of the compute accelerator, in accordance with some embodiments of this disclosure;

FIG. 12 depicts an example data flow of a compute cluster including a plurality of compute accelerators, in accordance with some embodiments of this disclosure; and

FIG. 13 is a flowchart of an example process including mapping a model to a plurality of devices and transmitting data from a first set of PEs to a respective second set of PEs located along a translation vector, in accordance with some embodiments of this disclosure.

### DETAILED DESCRIPTION

The present disclosure describes systems and methods including a domain translation algorithm that reduces the internode latency between compute clusters, enabling strong scaling of the processing workloads. In some embodiments, a system includes one or more compute clusters of respective pluralities of devices such as compute accelerators or other computational hardware. In some embodiments, the plurality of devices may include one or more large-chip devices. For example, a large-chip device may include a plurality of PEs arranged on a large substrate such as a substantially whole wafer, wherein the PEs are configured to perform computations as a single chip. In some embodiments, a large-chip device may include a large substrate of processing elements with no chiplets or interposer. In some embodiments, the PEs may be interconnected using a compute fabric.

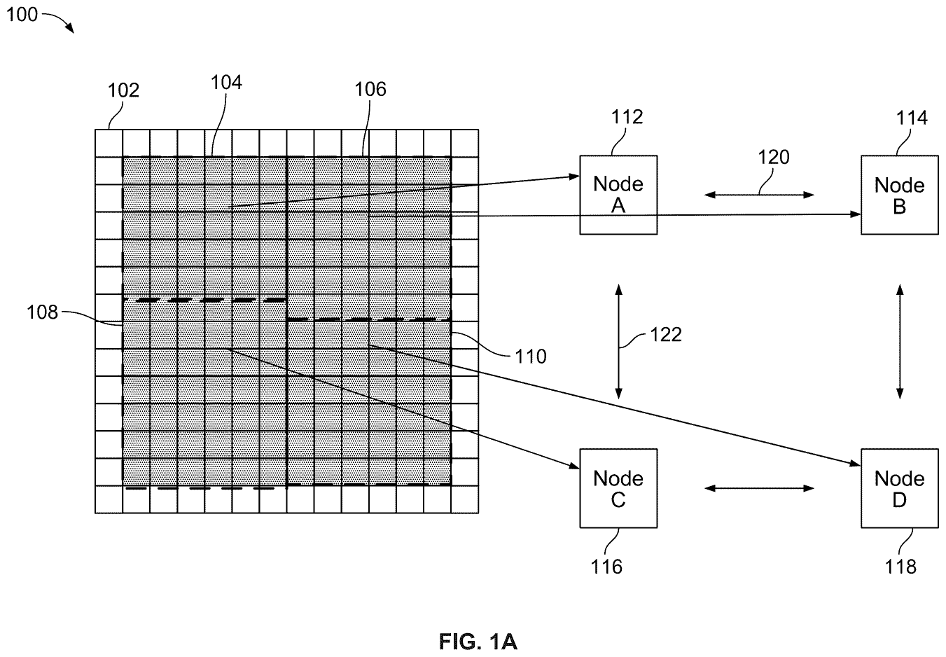

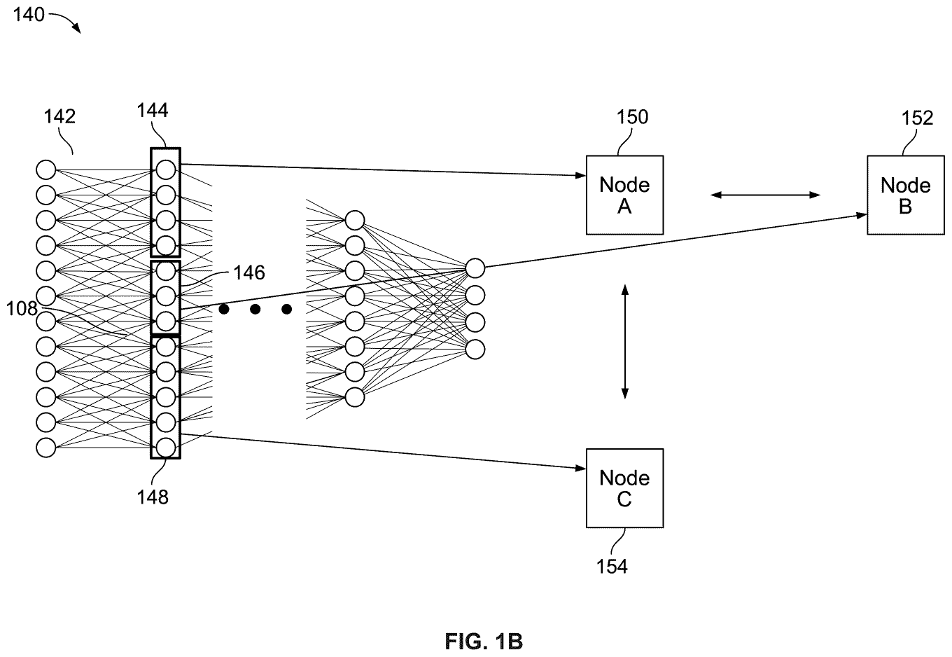

FIG. 1 depicts some example scenarios 100, 140 in which a domain and/or a model are mapped to a plurality of compute nodes, in accordance with some embodiments of this disclosure. In some embodiments, the plurality of compute nodes corresponds to a plurality of devices. At FIG. 1A, a computational model may include domain 102. Domain 102 is discretized as a mesh using one or more domain decomposition techniques and organized as a plurality of subdomains (e.g., subdomains 104-110). For example, the computational domain may be decomposed using any of finite differences, finite elements, finite volumes, adaptive mesh discretization, etc., variants thereof, and/or combinations thereof. In some embodiments, the subdomains 104-110 may be partitioned such that the sizes and/or shapes are the same. In some embodiments, the subdomains 104-110 may be partitioned such that the sizes and/or shapes are different. It is noted that the subdomains may be generated using any suitable decomposition technique such that the subdomains may have any size, shape, number of dimensions, etc., and that the sizes, shapes, number of dimensions, etc., of subdomains 104-11 are provided for illustrative purposes and is intended to be non-limiting. For example, domain 102 may partitioned using triangles, rectangles, hexagons, any polygonal shape, ellipsoidal shape, meshes and shapes of any number of dimensions, etc., variants thereof, and/or combinations thereof.

Each subdomain may be associated with one or more computations, such as stencil-based computations or any suitably parallelizable task. Respective computations of the subdomains 104-110 may be mapped to at least one compute node of the plurality of compute nodes 112-118. The compute node may perform the respective computations based on the mapping, generating output values during one or more iterations. For example, a device corresponding to node 112 may perform the computations for subdomain 104. Data may be transmitted between nodes using respective couplings. For example, node 112 and node 114 may exchange data using coupling 120. For example, node 112 and node 116 may exchange data using coupling 122. It is noted that there may be any number of compute nodes and any number of communication paths between compute nodes included in the principles set forth in the present disclosure. In some embodiments, node 112 may be coupled to node 118, and/or node 114 may be coupled to node 116.

As an illustrative example, the domain 102 may represent a region of interest for simulating a physical phenomenon (e.g., heat flow), and computations for simulating the physical phenomena may be distributed among the subdomains. The distributed computations may be performed concurrently using the compute nodes 112-118 to generate respective output values. The output values may be transmitted between compute nodes to perform subsequent computations.

It is noted that the domain is depicted as two-dimensional for illustrative purposes and that a computational model may have a domain of any number of dimensions and may be suitably discretized without departing from the principles set forth in the present disclosure.

FIG. 1B depicts a machine learning model represented as a neural network 142. Neural network 142 includes a plurality of network layers, each layer including one or more model nodes. For example, a network layer may include a first node set 144, a second node set 146, and a third node set 148, wherein each node set may be associated with respective computations. The neural network 142 may be mapped to a plurality of compute nodes (e.g., nodes 150-154). As an illustrative example, the first node set 144 is mapped to node 150, the second node set 146 is mapped to node 152, and the third node set 148 is mapped to node 154. The nodes 150-154 may concurrently perform the respective computations associated with the mapped node set to generate interim data for the next network layer of the neural network 142. For example, a device corresponding to node 150 may perform the computations.

It is contemplated that the above-described models are intended to be illustrative and non-limiting and that any suitably parallelizable set of tasks may be mapped to any number of compute nodes in the principles set forth in the present disclosure.

As described in preceding paragraphs, the plurality of compute nodes may correspond to a plurality of devices. In some embodiments, each device may include respective PEs that perform the assigned computations. For example, each device may include PEs in a grid arrangement.

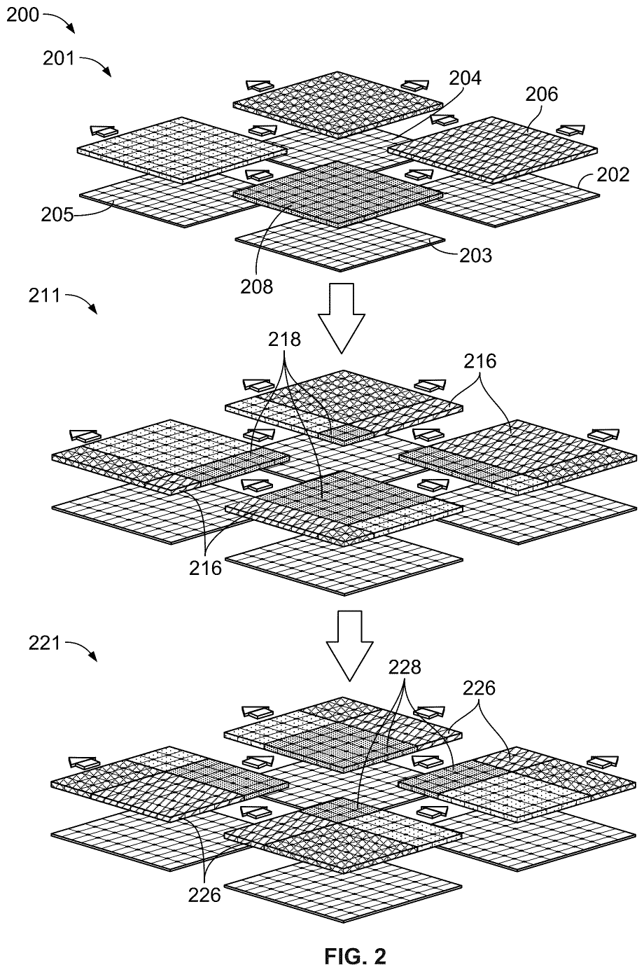

FIG. 2 depicts an example system 200 including unidirectionally transmitting data for respective PEs of a plurality of devices (e.g., devices 202-205) along a direction of translation, in accordance with some embodiments of this disclosure. Diagrams 201, 211, 221 show example snapshots of the flow of datasets between the devices over time. Each device of the system 200 includes respective PEs arranged on a grid. The PEs perform the respective computations based on a mapping, such as described with respect to FIG. 1, and generate interim datasets at each step. During a first step at diagram 201, the devices generate first datasets. For example, device 202 may generate a dataset 206, and device 203 may generate a dataset 208. The datasets 206, 208 may be transmitted to respective PEs positioned along the direction of translation (e.g., to a set of PEs positioned in a diagonal direction). The datasets, or portions thereof, may be transmitted to one or more PEs at a different device. During a second step at diagram 211, respective portions of the dataset 206 are transmitted to PEs at each of devices 202-205, and respective portions of the dataset 208 are transmitted to PEs at each of devices 202-205. The devices may perform respective computations based on the datasets and generate second interim datasets (e.g., datasets 216, 218). During a third step at diagram 221, respective portions of the dataset 216 are transmitted to PEs at each of devices 202-205, and respective portions of the dataset 218 are transmitted to PEs at each of devices 202-205. The devices may perform respective computations based on the datasets and generate third datasets (e.g., datasets 226, 228). By transmitting the data unidirectionally (e.g., as shown by the example dataflow of diagrams 201, 211, 221), the data is communicated across the node boundary with the direction of translation and does not return against the direction of translation. The communication latency between the devices 202-205 is reduced such that the latency delays processing of each dataset once per cycle that the dataset crosses the width of the device (e.g., the width of the grid of PEs). It is noted that a description including four devices is provided for illustrative purposes and is intended to be non-limiting and that any number of devices in any suitable arrangement may be included in the principles set forth in the present disclosure. For example, the devices may be secured in a rack support structure and coupled such that the data may be transmitted as described with respect to FIG. 2. For example, the devices may be located remote from each other and coupled using a network such that the devices may unidirectionally transmit the data and perform the computations as a unit.

In some embodiments, the datasets may be transmitted such that their respective sets of PEs overlap. For example, one or more PEs of device 202 may receive the dataset 206 and be used to generate a portion of the dataset 216. In some embodiments, the first set of PEs may be the same as the second set of PEs. For example, a first dataset (e.g., dataset 206) may be transmitted using one or more loop connections by one or more PEs at a device boundary of device 202 such that the dataset returns to the same device (e.g., to one or more PEs of device 202).

In some embodiments, a device includes a plurality of PEs arranged based on a spatial architecture. For example, the device may include memory that is distributed among the PEs. For example, each PE may include a portion of the memory positioned proximate to the site of compute of the PE. In some embodiments, each PE includes a compute element and local memory (e.g., static random-access memory (SRAM)). In some embodiments, each PE may include or be coupled to a router configured to transmit data concurrently processing of data (e.g., using the compute element), enabling rapid and reliable transmission.

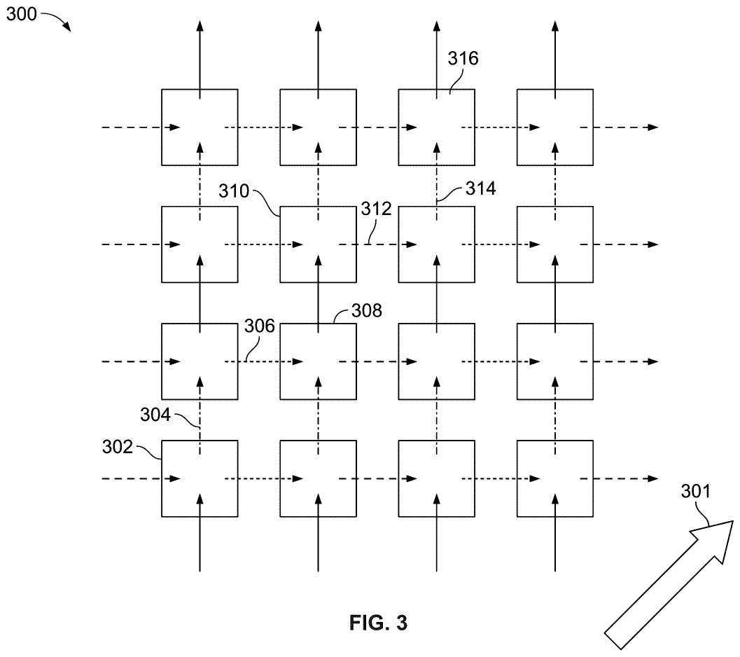

FIG. 3 depicts a data flow diagram of an example system 300 including a plurality of devices (e.g., devices 302, 308, 310, 316) having data transmitted along a direction of translation 301, in accordance with some embodiments of this disclosure. The system 300 includes a plurality of devices coupled together (e.g., using respective paths 304, 306, 312, 314) such that the data may be transmitted to a device that is positioned along the direction 301. For example, the data may flow from left to right and/or from down to up. It is noted that the devices of system 300 are arranged as a grid for illustrative, non-limiting purposes and that any suitable arrangement of the devices is included in the principles set forth in the present disclosure.

In some embodiments, data may be shared across some, most, or all processor memory. In some embodiments, processors may be configured to enable asynchronous data movement and computation. For example, each processor may execute the same or different instruction during one or more steps. At the system 300, the data may be shifted up and/or right to reach the next assigned device for processing.

In some embodiments, the data is shifted by one or more units per step. As an illustrative example, first data from device 302 may be transmitted using path 304 during a first step and then transmitted using path 306 during a second step to reach device 308. As a second, non-limiting example, second data from device 310 may be transmitted using path 312 during a first step and then transmitted using path 314 to be processed by device 316. The first and second data may be concurrently transmitted and/or processed over time by respective devices.

In some embodiments, a sequence of computations and data communications may be arranged to occur in one or more time steps. For example, a counter (e.g., to indicate time step and/or iteration) may be incremented after a sequence is completed. Referring to the preceding example, the sequence of steps may be performed, and a counter may be incremented after the sequence is completed. For example, a counter may be incremented by one iteration after the first data is received at device 308 from device 302 and/or the second data is received at device 316 from device 310. In some embodiments, respective portions of the data may be concurrently transmitted along respective routes (e.g., along different routes from device 302 to device 308) within a counter increment and/or time step. In some embodiments, one or more intervening devices along the respective routes may perform assigned computations and generate updated data that is transmitted to the next device in the sequence. In some embodiments, the computations, or a portion thereof, may be performed by the one or more intervening PEs along the route before the data is transmitted from a first device (e.g., from device 302). In some embodiments, the computations, or a portion thereof, may be performed by one or more intervening PEs along the route before the data is transmitted to a second device (e.g., to device 308).

In some embodiments, the plurality of devices is configured to execute the above-described data flow in a self-orchestrated manner. For example, the plurality of devices may be configured before or at compile time to automatically transmit the data as described with respect to FIG. 3. Once the system 300 initiates the computations, there may be no need for host-device interaction. For example, the computations may be distributed across the plurality of devices, and by automating the data flow along the direction 301, the inter-device communication latency may be reduced such that the efficiency of system 300 is comparable to the efficiency of a single device. In some embodiments, a system may be configured to adjust the step rate and/or grid points per compute node. For example, the step rate and/or grid points per compute node may be optimized such that communication time is comparable to computation time.

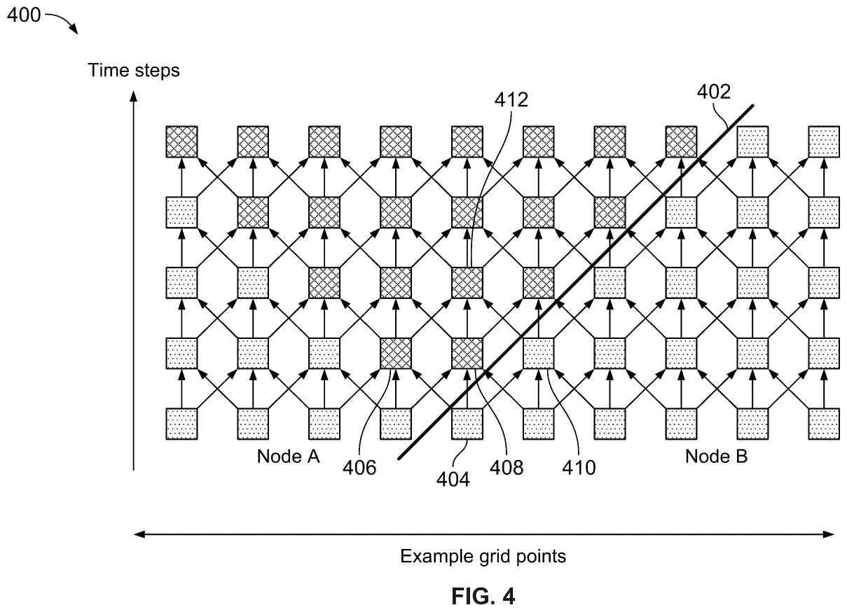

FIG. 4 depicts an example compute grid 400 with reduced network latency between compute nodes, in accordance with some embodiments of this disclosure. The grid 400 includes grid points of a first compute node and grid points of a second compute node. As an illustrative example, computations may be processed along the grid 400 based on a three-point stencil in one dimension. It is noted that the grid 400 is described with respect to one dimension for clarity and is intended to be non-limiting. The described example may be extended to any number of dimensions without departing from the principles set forth in the present disclosure.

An internode boundary 402 may indicate a latency contribution due to communication between the first node and the second node. For example, data from grid point 404 of the second compute node may add time units by crossing the boundary 402 to reach grid point 406 or grid point 408 of the first compute node as compared to the time to reach grid point 410 of the second compute node (e.g., without crossing the boundary 402). During subsequent steps, the data may remain in the same compute node after crossing the boundary 402 once by translating the mapping by one or more grid points per iteration. In some aspects, translating the mapping enables the dependency across the boundary 402 to be unidirectional. For example, the boundary 402 may be shifted along a direction of translation (e.g., by one grid point to the right), and data at grid point 406 or grid point 408 no longer cross the boundary 402 and progresses to the next grid point (e.g., grid point 412), reducing the number of internode communications and mitigating the network latency contribution.

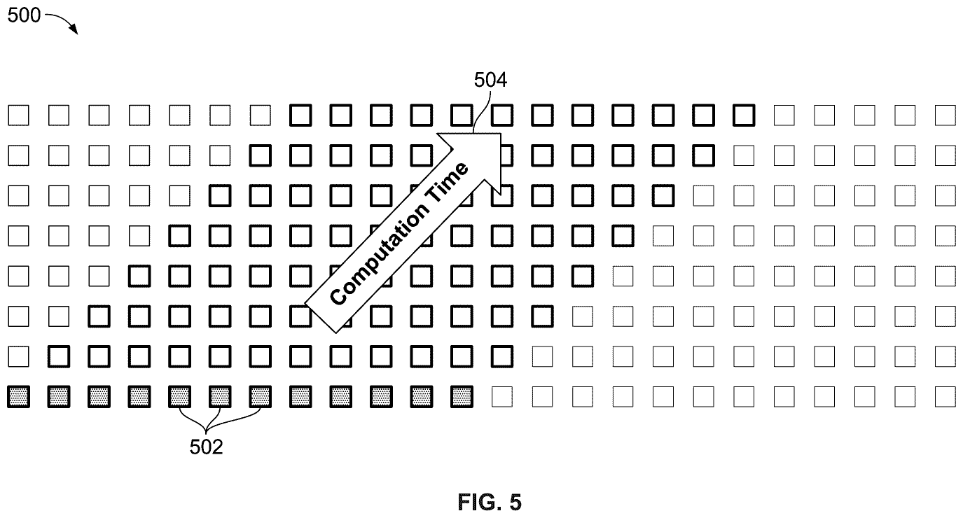

FIG. 5 depicts an example system 500 with data unidirectionally flowing along a direction of translation 504, in accordance with some embodiments of this disclosure. In some embodiments, the number of grid points and/or step rate are adjusted to balance the computation time and communication time. For example, each device respectively mapped to grid points 502 may perform the associated computations in about the same amount of time as the data is transmitted along the direction 504. The system 500 may be arranged such that the data is shifted up and right during one or more steps and that data for different subdomains at the same step is along the same row of the grid. Using the unidirectional dataflow along the direction 504 ensures that the data remains on the same compute node. In some embodiments, the dataflow is configured such that the data and instruction execution pathway are coincident and local on the devices over one or more execution cycles for a number of steps regardless of the number of devices involved. As described in preceding paragraphs, the dataflow is automated to follow the direction 504 in some embodiments.

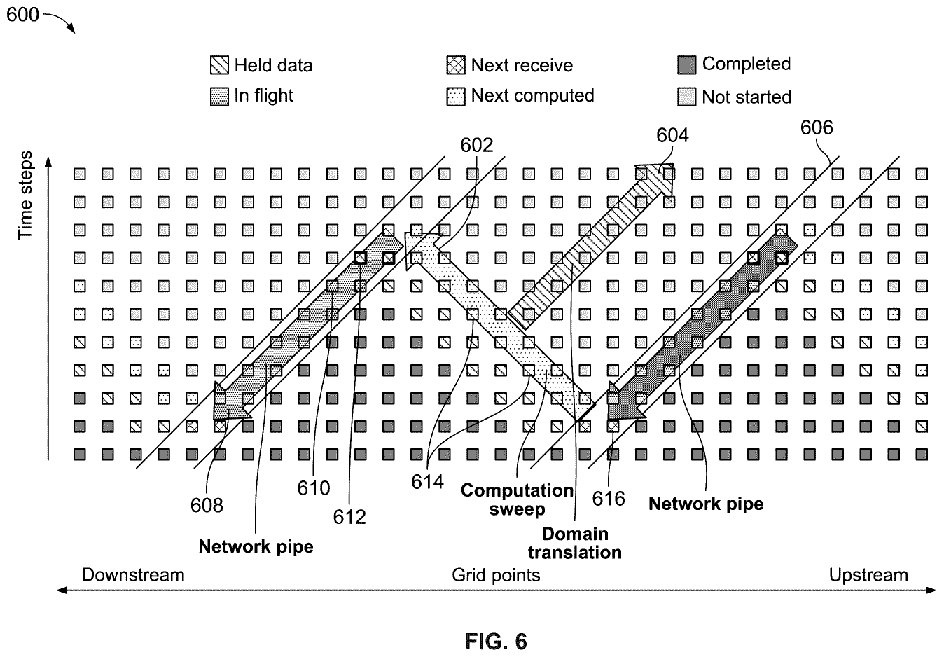

FIG. 6 depicts an example system 600 with data flow over one or more computation steps between compute nodes, in accordance with some embodiments of this disclosure. The system 600 includes a plurality of compute nodes, wherein a first compute node is coupled to one or more compute nodes using respective network pipes (e.g., pipe 608). The network pipes include respective internode boundaries (e.g., boundary 606) that indicate high network latency contribution to data crossing the boundary. The system 600 may be configured such that computations are performed along a compute direction 602 and data is transmitted along a translation direction 604. FIG. 6 indicates a steady-state cycle snapshot for the system 600 as the computations and data flow along their respective directions 602, 604. One or more nodes (e.g., node 610) may receive data from a network pipe (e.g., network pipe 608). One or more nodes (e.g., node 612) may store data (e.g., from a previous step) and/or receive data from the network pipe. One or more nodes (e.g., nodes 614) may perform associated computations. One or more nodes (e.g., node 616) may receive data from a network pipe (e.g., network pipe 606) during the next step.

As an illustrative example, node 616 may receive one or more data packets from a network pipe. A computation sweep may be initiated along the compute direction 602 including nodes 614, wherein the involved nodes use the stored data to generate the next dataset (e.g., a new grid point state). At the end of the computation sweep, the computed values may be transmitted downstream using the network pipe 608 (e.g., to nodes 610, 612). In this example, the system 600 may be configured such that the time for the computation sweep is about the same time for a network packet to advance a unit through the network pipe. Each node may process a number of computation sweeps (e.g., a full network pipe's amount) before receiving the next dataset from the network pipe. For example, a dataset may be transmitted and processed by PEs across a width of a device before a new dataset arrives from another device.

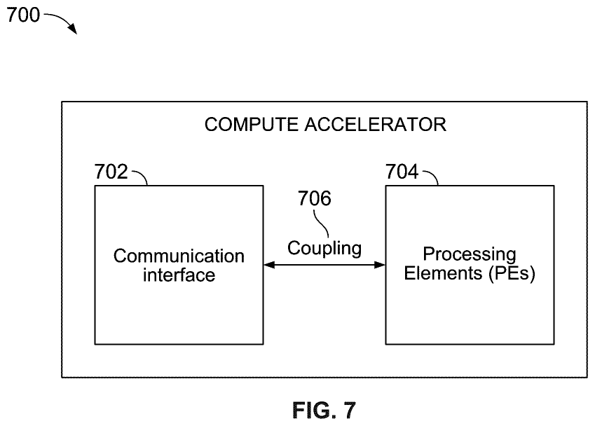

FIG. 7 depicts a block diagram illustrating an example compute accelerator 700. Compute accelerator 700 includes a communication interface 702 and associated circuitry (e.g., input/output (I/O) circuitry) and one or more PEs 704, enabled to communicate with each other, as illustrated by Coupling 706. In some embodiments, communication interface 702 may include one or more field-programmable gate arrays (FPGAs). In some embodiments, one or more servers, devices, and/or other systems may be communicatively coupled to compute accelerator 700 using the interface 702. Compute accelerator 700 may be configured to perform processing (e.g., training and/or inference) with neural networks, such as by computing weights based on placement information and/or training information. Compute accelerator 700 may be configured to provide the weights as results via one or more communication paths (e.g., between PEs 704, between PEs 704 and interface 702, and/or to one or more other devices using the interface 702). In some embodiments, PEs 704 may include a relatively large number of PEs (e.g., about 10,000 or more), each PE configured to independently perform routing and/or computations. In some embodiments, compute accelerator 700 may include a large-chip device, wherein PEs 704 are implemented on a large substrate and configured to function analogous to a single chip. For example, respective pluralities of PEs may be implemented on respective dice of a single large substrate (e.g., a rack-width substrate, a substantially whole wafer, etc.). Interface 702 may be configured to couple one or more of PEs 704 to information provided via one or more communication paths using coupling 706. The coupling may include conversion to/from a first data structure (e.g., modified Ethernet frames, network packets, etc.) from/to a second data structure (e.g., fabric packets, network packets, etc.). In some embodiments, processing the information may include quantizing model weights or other values (e.g., converting from a floating-point number format to a fixed-point number format, encoding numerical values, decoding values in a block numeric format, etc.).

As used herein, the term “model parameter” or “parameter” refers to any model parameter including variables (e.g., model weights), number of layers, interlayer connections, number of nodes in a respective layer, etc., that may be adjusted during training and/or inference.

Any compute parameters described in the present disclosure may include any combination of scalars, vectors, matrices, tensors, and so forth, such as arrangements of an arbitrary number and an arbitrary complexity of elements. For example, the parameters are of various dimensions, such as one-dimensional, two-dimensional, three-dimensional, and otherwise multidimensional. For example, the parameters are of various datatypes, such as, integer and floating-point. For example, the parameters (or respective portions thereof, e.g., an exponent or a mantissa) are represented with various precisions (sometimes referred to as widths), such as, 8-bit, 16-bit, 32-bit, 64-bit, and so forth.

The terms “an embodiment”, “embodiment”, “embodiments”, “the embodiment”, “the embodiments”, “one or more embodiments”, “some embodiments”, and “one embodiment” mean “one or more (but not all) embodiments” unless expressly specified otherwise.

The terms “including”, “comprising”, “having” and variations thereof mean “including but not limited to”, unless expressly specified otherwise.

An enumerated listing of items does not imply that any or all of the items are mutually exclusive, unless expressly specified otherwise.

The terms “a”, “an” and “the” mean “one or more”, unless expressly specified otherwise.

Devices, or components thereof, that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. For example, a variety of optional components may be described to illustrate the wide variety of possible embodiments. Further, although process steps, method steps, algorithms, or the like may be described in a sequential order, such processes, methods, and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it is noted that more than one device/article (whether or not they cooperate) may be used in place of a single device/article. Similarly, where more than one device or article is described herein (whether or not they cooperate), it is noted that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments need not include the device itself.

At least particular operations that may have been illustrated in the figures show particular events occurring in a particular order. In some alternative embodiments, particular operations may be performed in a different order, modified, combined, or removed. Moreover, steps may be added to the above-described circuitry(ies) and conform to the described embodiments without departing from the principles set forth in the present disclosure. Some operations described herein may occur sequentially, and/or particular operations may be processed in parallel. Any operation may be performed by a single processor or by distributed processors.

As referred to herein, reference to a “substrate” are applicable to embodiments of a large substrate (e.g., a rack-width substrate, printed circuit board (PCB), organic substrate, a whole or substantially whole wafer, etc.) as well as to embodiments of a significant portion of a substrate (e.g., a significant portion of a wafer).

In some embodiments, a compute accelerator may include one or more specialized components, such as processing elements, device components, or other hardware elements. Some implementations include one or more processing circuit elements such as transistors, resistors, inductors, capacitors, wire interconnects, combinatorial logic (e.g., NAND, NOR) gates, latches, register files, memory arrays, tags for memory arrays, content-addressable memories, flash, ROM, DRAM, SRAM, Serializer/Deserializer (SerDes), I/O drivers, and the like, such as implemented via custom logic, synthesized logic, ASICs, and/or FPGAs. Some example processing elements include one or more application specific integrated circuits (ASICs), such as central processing units (CPUs), graphics processing units (GPUs), tensor processing units (TPUs), neural processing units (NPUs), etc., including combinations and/or variants thereof. One or more compute accelerators may include processing elements coupled via a unifying compute fabric (“fabric” henceforth) and enabled to communicate with each other via the fabric. The processing elements and the fabric may be collectively referred to as a fabric of processing elements on a single compute accelerator or a plurality of compute accelerators coupled to each other.

In some embodiments, a processing element includes a router to communicate data packets (e.g., network packets, fabric packets, etc.) via the fabric and a CE to process the data packets. In some embodiments, a router may be coupled to a plurality of elements: a fabric, an off ramp to the compute element, and an on ramp from the compute element. In some embodiments, a coupling between the router and the fabric enables communication between the router and, e.g., four logically and/or physically adjacent processing elements. The router variously receives data packets from the fabric and the on ramp. The router variously transmits data packets to the fabric and the off ramp.

In some embodiments, a CE includes hardware elements that collectively execute the instructions based on receiving an associated data packet by performing operations specified by the instructions (e.g., arithmetic operations, control flow operations, and load/store operations). In some embodiments, the instructions are provided to the compute element separately from the associated data packet. Examples of some hardware elements include picker queues, a picker, a task definition table, an instruction sequencer, an instruction decoder, a data sequencer, a register file, a memory, a pseudo-random number generator, and an arithmetic logic unit (ALU). Some implementations of the hardware elements are in accordance with hardware logic circuitry elements as described elsewhere herein. A compute element (CE) may be referred to as a compute engine. A compute scheduler may be referred to as a picker, and a compute scheduler queue may be referred to as a picker queue. A CE may be configured to process data packets by initiating tasks and executing instructions associated with the data packets, and accessing data associated with the data packets and/or the instructions. The instructions are in accordance with an instruction set architecture comprising arithmetic instructions, control flow instructions, datatype conversion instructions, configuration instructions, fabric management instructions, and load/store instructions. The instructions operate on operands comprising various datatypes, e.g., integer datatypes and floating-point datatypes of various widths. The operands variously comprise scalar operands and vector operands. In some embodiments, a vector variously represents, e.g., weights of a neural network, inputs or stimuli of a neural network, activations of a neural network, and/or partial sums of a neural network. In some scenarios, a vector is a sparse vector (e.g., a vector of neuron activations) and comprises sparse data elements (e.g., only non-zero elements). In some other scenarios, a vector is a dense vector (e.g., pixel values) and comprises dense data elements (e.g., all elements of the vector, including zero elements).

In some embodiments, a fabric includes a collection of logical and/or physical couplings between processing elements and/or within a single processing element. The fabric may be configured to implement logical and/or physical communication topologies such as a mesh, a 2D mesh, a 3D mesh, a hypercube, a torus, a ring, a tree, or any combination thereof. In some embodiments, a physical coupling between processing elements may include a set of physical interconnects (comprising optional and/or selective buffering) between physically-coupled processing elements. A first example of physically-coupled processing elements is immediately physically adjacent processing elements, such as a first processing element located directly beside (such as ‘north’, ‘south’, ‘east’, or ‘west’) of a second processing element. A second example of physically-coupled processing elements is relatively physically nearby processing elements, such as a first processing element located within a relatively small number of intervening processing elements, e.g., one or two ‘rows’ and/or ‘columns’ away from a second processing element. A third example of physically-coupled processing elements is relatively physically far away processing elements, such as a first processing element located physical relatively far away from a second processing element, such as a distance limited by signal propagation (with or without optional and/or selective buffering) within a clock cycle and/or clock sub-cycle associated with the processing elements. An example of physical coupling within a single processing element (having, e.g., a compute element and a router) is an on ramp coupling output information from the compute element to the router, and an off ramp coupling input information from the router to the compute element. In some embodiments, the router routes information from the on ramp to the off ramp. The router may route from the on ramp and through a number of zero or more hops to one or more consecutively adjacent routers and/or zero or more off-ramps (e.g., a plurality of off-ramps).

In some embodiments, memory or storage includes one or more elements enabled to retain state information, e.g., any one or more of: a flip-flop, a latch or an array of latches, a register or an array of registers, a register file, a memory, a memory array, a magnetic storage device, an optical storage device, SRAM, DRAM, flash, and ROM. In some embodiments, storage is volatile (e.g., SRAM or DRAM) and/or non-volatile (e.g., flash or ROM).

In some embodiments, a compute accelerator may include wafer-scale integration by implementing a system using all or a significant portion of a large substrate as an element of the system, e.g., by leaving a large substrate whole or substantially whole with relatively little or no singulation. In some embodiments, wafer-scale integration enables connecting multiple elements in a system via substrate interconnects formed using semiconductor fabrication processes instead of via inter-chip interconnect, and may improve any one or more of improved performance, cost, reliability, and energy efficiency. As an illustrative example, a system implemented using wafer-scale integration technology enables implementation of more than one billion PEs on a single substrate, each of the PEs having bandwidth to nearest physical neighbors that is greater than a comparable system using other-than wafer-scale integration technology. The greater bandwidth enables the system implemented using wafer-scale integration technology to relatively efficiently train and/or perform inferences for larger neural networks than the system implemented using other-than wafer-scale integration technology.

In some embodiments, a logical coupling between processing elements includes one or more communication channels (e.g., one or more virtual channels) as implemented by routers within processing elements. A route between a first processing element and a second processing element is implemented, e.g., by routers within processing elements along the route forwarding in accordance with the communication channel and routing configuration information. An example of a logical coupling within a single particular processing element (having, e.g., a router) is a communication channel as implemented by the router, enabling the particular processing element to send information via the communication channel to the particular processing element. The router forwards with respect to the particular processing element in accordance with the communication channel and routing configuration information.

In some embodiments, a data packet (e.g., fabric packets, network packets, etc.) includes a bundle of information communicated between processing elements via the fabric. A data packet may be referred to as a wavelet in some embodiments. In some embodiments, a data packet may include one or more fields indicative of a payload and/or a communication channel (e.g., a communication channel identifier). A payload may include data and may be associated with instructions. For example, a first response to a data packet received by a compute element of a processing element may include the compute element initiating a task, such as corresponding to processing of instructions associated with the data packet. For example, a second response to a data packet received by a compute element of a processing element may include the compute element processing data of the data packet. Some example types of data packets include dense packets and sparse packets, as well as data-type and control-type.

Data packets may be used, for example, for communicating between processing elements. For example, a first processing element may transmit data packets to a second processing element. For example, an external device (e.g., from interface 702) may transmit data packets to a processing element. For example, a processing element transmits data packets to an external device (e.g., using interface 702).

In some embodiments, a communication channel includes one or more communication pathways specified by a communication channel identifier (e.g., a color field) and may be enabled, e.g., by a fabric and one or more routers. A communication channel may be referred to as a virtual channel in some embodiments. A data packet including a particular communication channel identifier is sometimes referred to as being associated with a particular communication channel (e.g., associated with a particular color). A first example of a communication channel identifier may be a fabric color specifying a communication channel between two different processing elements. In some embodiments, a communication channel identifier is a 5-bit integer. A second example of a communication channel identifier is a local color specifying a communication channel from a processing element to the processing element. In some embodiments, a communication channel identifier is a 6-bit integer and specifies one of a fabric color and a local color.

An example task may include a collection of instructions executed in response to a data packet. An example instruction may include an operation and optionally one or more operands specifying locations of data elements to be processed in accordance with the operation. A first example of an operand specifies data elements in memory. A second example of an operand specifies data elements communicated (e.g., received or transmitted) via the fabric. An example of a data sequencer determines the locations of data elements. An example of an instruction sequencer determines an address in memory of instructions associated with a data packet.

An example picker queue is enabled to hold data packets received via an off ramp of the fabric for processing in the compute element. An example of a picker selects a data packet from the picker queue for processing, and/or selects an active unblocked virtual channel identifier for processing to initiate a corresponding task.

An example of an integrated circuit (IC) is a collection of circuitry implemented on one or more portions of semiconductor material, such as a single die or a plurality of dies. An example of 3D-stacking of dies is providing mechanical connectivity and/or electrical connectivity between the dies, e.g., in a dimension orthogonal to a major surface of the dies, to form a unit. The mechanical connectivity and/or the electrical connectivity are variously implemented, e.g., via one or more of solder balls, microbumps, hybrid bonds, and through-substrate vias. An example of 2.5D stacking of dies is providing mechanical connectivity and/or electrical connectivity between the dies via a common element (e.g., an interposer) to form a unit, wherein the mechanical connectivity and/or electrical connectivity between each die and the substrate is in a dimension orthogonal to a major surface of the die. The mechanical connectivity and/or the electrical connectivity are variously implemented, e.g., via one or more of solder balls, microbumps, and through-substrate vias. An example of an application-specific integrated circuit (ASIC) is an IC configured for a particular use or application.

An example of a package is an element enabled to mechanically retain and/or contain one or more electronic circuits and/or to electrically interconnect one or more electronic circuits. Example electronic circuits are any one or more of one or more portions of semiconductor material, one or more dice, one or more interposers, and one or more substrates. Particular examples of packages include a ball-grid array (BGA) package and variants thereof. Some ICs include a package. An example of a substrate is an element to mechanically retain and/or electrically interconnect one or more dice and/or one or more packages. An example of a substrate includes a PCB, to, e.g., retain and interconnect packages. An example of a substrate includes an interposer to, e.g., couple one or more 3D-stacked or 2.5-stacked dice. An example of a substrate includes a package, e.g., retaining a plurality of dice.

An example of inter-package communication is communication between packages, e.g., between a first package and a second package. A particular example of inter-package communication is communication between a first BGA mounted on a PCB and a second BGA mounted on the PCB. An example of intra-package communication is communication within elements of a package. A particular example of intra-package communication is communication between a first die in a package and a second die in the package. An example of intra-substrate communication is communication between elements of a substrate, such as between a first package mounted on a PCB and a second package mounted on the PCB. An example of inter-die communication is communication between dice, such as between a first 3D-stacked die of a package and a second 3D-stacked die of the package. Some inter-die communication is in accordance with intra-package communication. Some inter-die communication is in accordance with intra-substrate communication. An example of intra-die communication is communication between elements of a same die, such as between electrically interconnected routers of a same die.

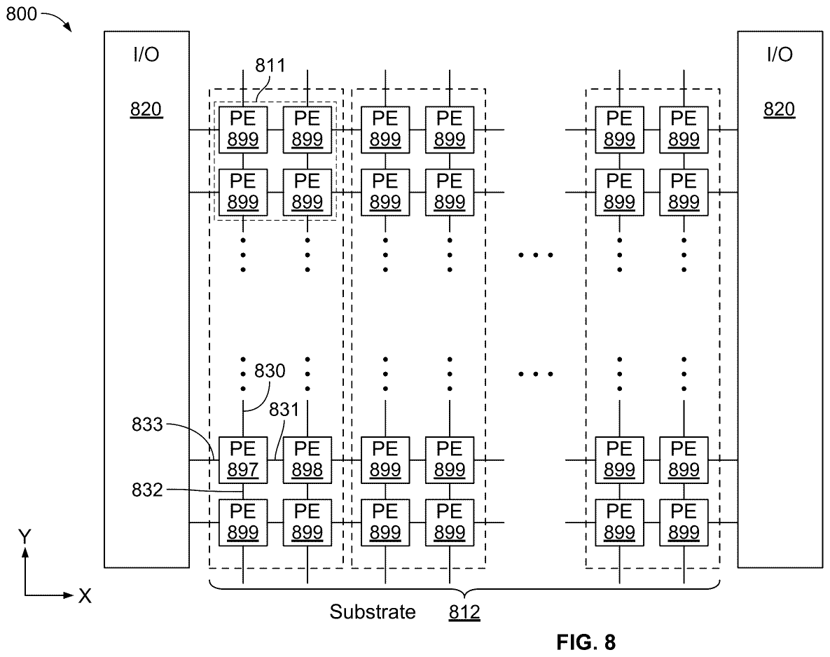

FIG. 8 depicts an example configuration of a compute accelerator 800 including a plurality of PEs disposed at a single substrate 812, in accordance with some embodiments of this disclosure. Each of PE 899 elements has couplings to other of PE 899 elements. Two of the PE elements (e.g., PE 897 and PE 898) are illustrated with unique identifiers and may be otherwise respectively identical to instances of PE 899. PE 897 is illustrated with identifiers for each of four couplings (North coupling 830, East coupling 831 with PE 898, and South coupling 832) to others of the PEs and one of the I/O 820 (West coupling 833) and may be otherwise identical to others of the PE elements illustrated. In some embodiments, the couplings are logical and/or physical. In some embodiments, the couplings are usable to communicate control packets, instructions, data packets, backpressure information, configuration information, routing information, etc. In some embodiments, all or any portions of the physical couplings are to physically adjacent PEs. In some embodiments, the PEs are physically implemented in a 2D grid. In some embodiments, the PEs are physically implemented in a 2D grid of aligned rectangles, and physically adjacent PEs correspond to PEs sharing a horizontal boundary (North/South PEs with respect to each other) and PEs sharing a vertical boundary (East/West PEs with respect to each other).

In some embodiments, the PEs (e.g., PEs 897, 898, 899) may include or be ASICs. For example, an array of identical instances of an ASIC may be formed on a substrate, and each of the ASICs includes a plurality of identical instances of a same PE (e.g., PE 899), forming a substrate (e.g., substrate 812) usable in large-chip fabrication techniques (e.g., wafer-scale integration). In some embodiments, one or more peripheral portions of the PEs are coupled to I/O 820. For example, I/O 820 may include a plurality of FPGAs configured to couple the PEs to external devices or other PEs. The PEs may be organized in any suitable manner such as sections of columns (e.g., replicated in a one-dimensional fashion to form a column). In some embodiments, the PEs may be organized in reticles such as reticle 811 including a square-organized section or a rectangular-organized section of PEs (e.g., replicated in a two-dimensional fashion to form a rectangular shape). Other organizations of the PEs on a substrate may be included in the principles set forth in the present disclosure.

In some embodiments, a set of parallelizable tasks may be mapped to one or more PEs 899 such that associated computations may be concurrently performed by the mapped PEs. In some embodiments, neurons associated with layers in a model (e.g., one or more neural networks) may be generally placed on PE 899 elements (e.g., in a left to right fashion or any other direction), with earlier layers (e.g., the input layer) at a first end and subsequent layers (e.g., the output layer) at a second end. As an illustrative example, data flow during training and/or inference may include three example stages, forward stage, delta stage, and/or chain stage. During the forward stage, stimuli may be applied to the input layer and activations from the input layer flow to subsequent layers, eventually reaching the output layer and producing a forward result. During the delta stage, deltas (e.g., differences between the forward result and the output data) are propagated in the backward direction. During the chain stage, gradients are calculated down respective columns based on the deltas (e.g., with respect to the weights in the neurons) as they are generated during the delta stage. In some embodiments, processing for one or more stages (e.g., forward, delta, chain) may be substantially overlapped with processing for another stage (e.g., chain).

In some embodiments, one or more components of compute accelerator 800 may correspond to one or more components of compute accelerator 700. In some embodiments, individual PE 899 elements correspond to individual PEs of PEs 704 of FIG. 7. In some embodiments, PEs 899 including respective ASIC elements correspond to any or all portions of PEs of PEs 704 implemented as individual integrated circuits. In some embodiments, PEs 899 including respective ASIC elements correspond to (optionally identical) any or all portions of PEs of PEs 704 implemented via respective dice of a substrate. In some embodiments, I/O 820 elements may correspond to interface 702 of FIG. 7.

In some embodiments, Substrate 412 includes any one or more of a large substrate, an entire wafer, a portion of a wafer, a single ASIC, a plurality of ASICs, a plurality of dice, a plurality of 3D-stacked dice, and/or a PCB comprising one or more of the foregoing. For a first example, substrate 412 may include a portion of a wafer corresponding to a largest rectangle, according to physical granularity of the PEs (e.g., fitting inside an entire substantially circular wafer). For a second example, substrate 412 includes a grid arrangement of ASICs coupled via a PCB, each ASIC comprising a plurality of PEs.

In some embodiments, compute accelerator 800 may include a scaled compute fabric. In some embodiments, one or more PEs 899 may have a different amount of memory than the one or more other PEs 899. In some embodiments, one or more PEs 899 may utilize a different coupling technology than the one or more other PEs 899. In some embodiments, one or more PEs 899 may be implemented to use more power than the one or more other PEs 899, enabling, e.g., operation at a higher frequency. In some embodiments, one or more PEs 899 may be implemented to use less power than the one or more other PEs 899, restricting, e.g., operation to a lower frequency. In some embodiments, one or more PEs 899 or groups thereof may be configured for higher performance and/or configured to include increased local storage of data (e.g., weights), such as in a context of larger neural networks or other models. In some embodiments, groups of PEs 899 may be organized as compute clusters including respective high-bandwidth memory (HBM) or other memory coupled to the group.

In some embodiments, the PEs 899 may be coupled using a fabric. The fabric operates as a communication interconnect between all the PEs in the compute accelerator 800. For example, the fabric may be configured to transfer data packets, e.g., via 30-bit physical couplings to enable transfer of an entire data packet per cycle (e.g., core clock cycle). In some embodiments, the fabric is a local interconnect distributed throughput the PEs such that each PE is enabled to communicate directly with its (physical) neighbors. Communication to other-than (physical) neighbors may be performed via hops through intermediate nodes, e.g., others of the PEs, wherein the intermediate nodes are configured to route the information to the appropriate port without processing the information. In some embodiments, a distributed local fabric topology efficiently maps to a neural network workload, e.g., each layer sends data to a neighboring layer) and/or is implementable with relatively lower cost in hardware. As an illustrative example, compute accelerator 800 may include a fabric having a 2-D mesh of interconnects between neighboring PEs including “skip” connections (e.g., in the horizontal dimension) and/or “loop” connections (e.g., in the vertical dimension). Neighboring PEs may communicate with each other within about one or more time steps using the fabric. In this example, a skip connection enables PEs in a same row of the 2-D mesh and physically separated by one or more other PEs to communicate with each other as if the PEs were physically adjacent (e.g., within about one or more time steps). For example, a hop along a skip connection may be performed in about a single core clock cycle. In this example, a loop connection enables a PE at the bottom of a column of PEs to communicate with a PE at the top of the column as if the PEs were physically adjacent (e.g., within about one or more time steps). For example, a hop along a loop connection is performed in a single core clock cycle. It is noted that skip connections and/or loop connections may be configured to pass any number of intermediate nodes (e.g., any number of intervening PEs 899).

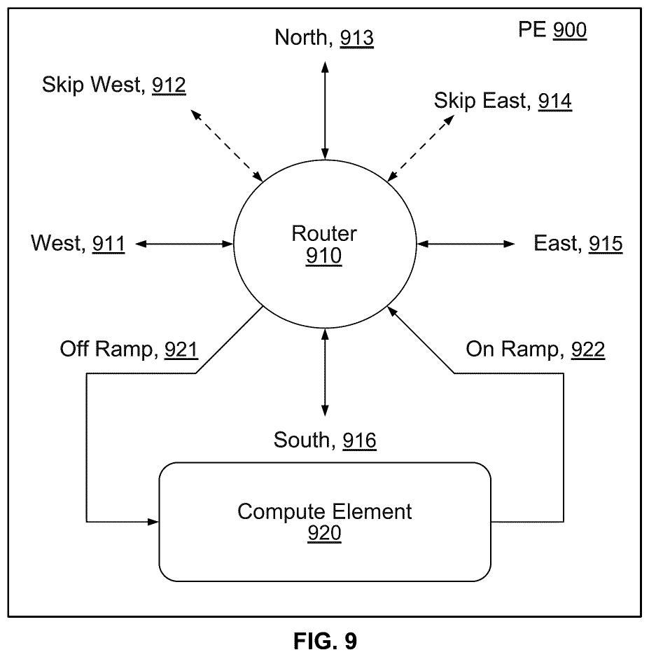

FIG. 9 depicts a block diagram illustrating an example processing element 900 and some components thereof, in accordance with some embodiments of this disclosure. PE 900 includes router 910 and CE 920. Router 910 may be configured to selectively and/or conditionally communicate (e.g. transmits and receives) packets between other PEs (e.g., logically adjacent and/or physically adjacent PEs) and PE 900 via couplings 911-916. Couplings 911-916 are illustrated as bidirectional arrows to emphasize the bidirectional communication of data packets on the couplings. For example, backpressure information may be transmitted on the couplings in the reverse direction of packet information the backpressure corresponds to. Router 910 may be configured to selectively and/or conditionally communicate packets to PE 900 (e.g., CE 920) via Off Ramp 921 and communicates data packets from PE 900 (e.g., CE 920) via On Ramp 922. Off Ramp 821 is illustrated as a unidirectional arrow to emphasize the unidirectional communication of data packets on the coupling (e.g., from router 910 to CE 920). For example, backpressure information may be transmitted on the coupling in the reverse direction of packet information (e.g., from CE 920 to router 910). On Ramp 922 is illustrated as a unidirectional arrow to emphasize the unidirectional communication of data packets on the coupling (e.g., from CE 920 to router 910). For example, backpressure information may be transmitted on the coupling in the reverse direction of packet information (e.g., from router 910 to CE 920).

Compute Element 920 may be configured to perform computations on data embodied in the received packets according to instruction address information, e.g., derivable from the packets. The instruction address information is used to identify starting addresses of tasks embodied as instructions stored in storage (e.g., any one or more of memory, cache, and register file(s)) of the CE. Results of the computations are selectively and/or conditionally stored in the storage and/or provided as data embodied in data packets communicated to the router for, e.g., transmission to the other PEs and or PE 900.

Each router may have five ports (e.g., couplings 911-916), connecting one each to its immediate cardinal neighbors using a fabric and to the local PE. Routers may forward data packets (e.g., messages of a compact size such as 32-bit messages) with low latency (e.g., on the order of nanoseconds). Each router may have any number of communication channels, such as 24 or more virtual channels. A virtual channel may multicast traffic arriving from any one of the five ports to any subset of the five ports. Routers may change the communication channel designation of a packet as it is forwarded.

Router 910 may selectively and/or conditionally communicates (e.g. transmits and receives) backpressure information between the other PEs and PE 900 via couplings 911-916. Router 910 selectively and/or conditionally transmits backpressure information to PE 900 via On Ramp 922. Router 910 receives backpressure information from PE 900 via Off Ramp 921. The backpressure information provided to the other PEs, as well as the backpressure information provided to PE 900, is used by the other PEs and PE 900 to stall transmitting data (e.g., packets) that would otherwise be lost due to insufficient queue space to store the data in Router 910. The backpressure information received from the other PEs and PE 900 is used respectively by Router 910 to prevent transmitting data (e.g., packets) that would otherwise be lost due respectively to insufficient queue space in the routers of the other PEs and insufficient space in input queues of Compute Element 920.

In various embodiments, any one or more of 911-916 are omitted.

In some embodiments, PE 900 is an embodiment of PEs 899, and/or elements of PE 900 correspond to an implementation of PEs 899. In some embodiments, North 913, East 915, South 916, and West 911 correspond respectively to North coupling 830, East coupling 831, South coupling 832, and West coupling 833.

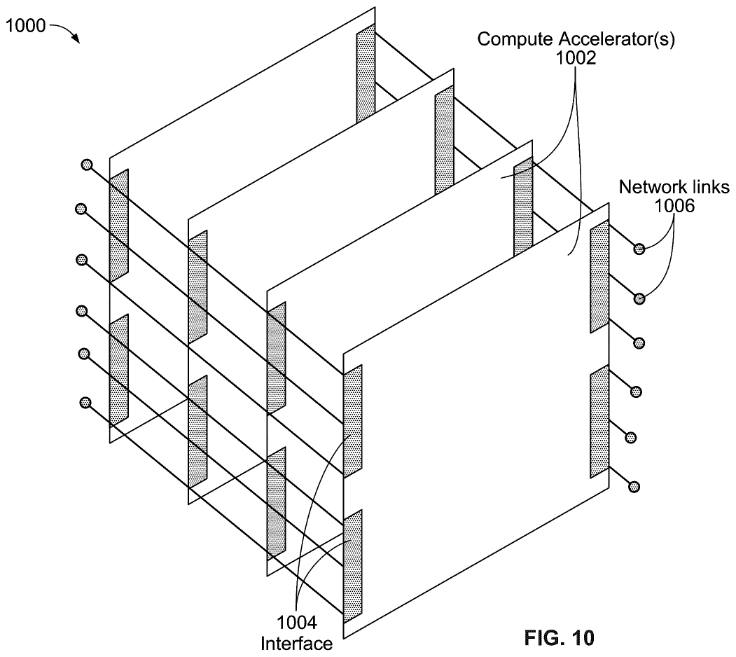

FIG. 10 depicts an example cluster system 1000 including a plurality of compute accelerators 1002 coupled together using one or more network links 1006, in accordance with some embodiments of this disclosure. In some embodiments, a compute accelerator unit, such as a large-chip device, includes a layout of reticles (e.g., tiles), each including one or more PEs and at least one router. Each compute accelerator 1002 may be configured to perform as a single chip and/or may include one or more interfaces 1004 coupling to other compute accelerators using the network links 1006. In some embodiments, the network links may include network switches for coupling the compute accelerators 1002.

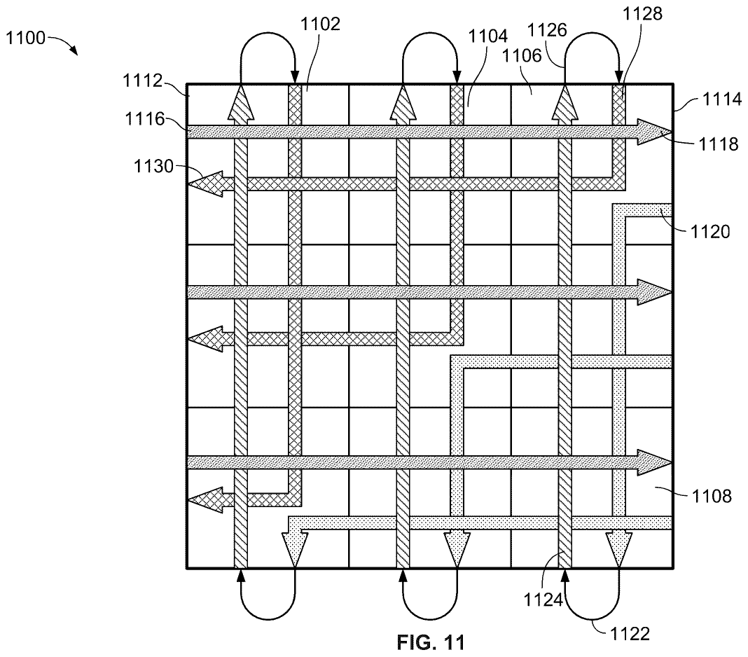

The system 1000 shows an example configuration for a switch topology. Any number of compute accelerators 1002 may be included in the system 1000. In some embodiments, a port index for one or more compute accelerators 1002 in the system 1000 may be assigned to the same network link. For example, a first network link (e.g., on the left side of the system 1000) may be assigned a first index, and a second network link (e.g., on the right side of the system 1000) may be assigned a second index. Data associated with the respective indices may be communicated to one or more compute accelerators using the assigned network link. In some embodiments, the interface 1004 may include specialized PEs or reticles for off-chip I/O. For example, the reticles may be located along the left and right edges of the compute accelerator. As an illustrative example, there may be 100 or more I/O reticles, distributed per side on the left and right. In this example, the compute accelerators 1002 may be fully connected, each configured as a compute node of a compute cluster. For example, each node may include ten or more high-speed (100 Gbps or more) ports and corresponding multi-port switches. In some embodiments, one or more first interfaces may be configured to receive data (e.g., the left and bottom interface of each compute accelerator), and one or more second interfaces may be configured to transmit data (e.g., the top and right interface of each compute accelerator). The respective PEs of each compute accelerator may be configured to automatically receive data from the one or more first interfaces and transmit data across the PE array towards the one or more second interfaces. For example, horizontally directed traffic may be received from the left edge and may be sent towards the right edge. Vertically directed traffic may be routed with a turn at a top edge, sent to the left edge, and received from the right edge as described with respect to FIG. 11.

FIG. 11 depicts an example data flow of a compute accelerator 1100 using one or more communication channels (e.g., channels 1116-1130) of the compute accelerator 1100, in accordance with some embodiments of this disclosure. As described in the preceding paragraph, data flowing along a particular direction may be routed based on the routing configuration shown at FIG. 11 or any suitable routing configuration. For example, horizontally directed traffic may be received from a left edge 1112 of the compute accelerator 1100 (e.g., using I/O 820 of FIG. 8) and may be sent towards a right edge 1114 of the compute accelerator 1100 (e.g., for transmission using I/O 820 of FIG. 8). Vertically directed traffic (e.g., from the right edge 1114) may be routed with a turn to a bottom edge, rerouted at the bottom edge towards the top edge, and be rerouted at the top edge towards the left edge 1112. In this manner, the data may be routed and/or processed by the PEs along the paths (e.g., any of PEs 1102-1108).

As an illustrative example following FIG. 11, a packet may enter from an interface at a receive point 1116 of the left edge 1112 the compute accelerator 1100, and be transmitted towards a transmit point 1118 of the right edge and/or processed by one or more of the intervening PEs 1102-1108. As an illustrative example following FIG. 11, a packet may enter from an interface at a receive point 1120 of the right edge 1114 and is turned toward the bottom edge (e.g., routed from the PE 1106 to the PE 1108). The packet may be received at the bottom edge and retransmitted towards the top edge of the compute accelerator 1000 (e.g., using a loop connection 1122 to a retransmit point 1124). The packet may be received at the top edge and retransmitted towards the left edge 1112 (e.g., using a loop connection 1126 to a retransmit point 1128). The packet may be transmitted off-chip at a transmit point 1130 of the left edge 1112. In some embodiments, the PEs are configured as a daisy chain for routing packets based on a routing configuration, e.g., as described with respect to FIG. 11. Respective communication channels of the left and right edges may be arranged to include receive and transmit points in an alternating pattern. For example, points 1116, 1130 may be alternating receive and transmit points of a communication interface at the left edge 1112 (e.g., any of the interfaces 1004). For example, routing packets towards the top edge (or bottom edge) may use two communication channels to turn the packet at the bend.

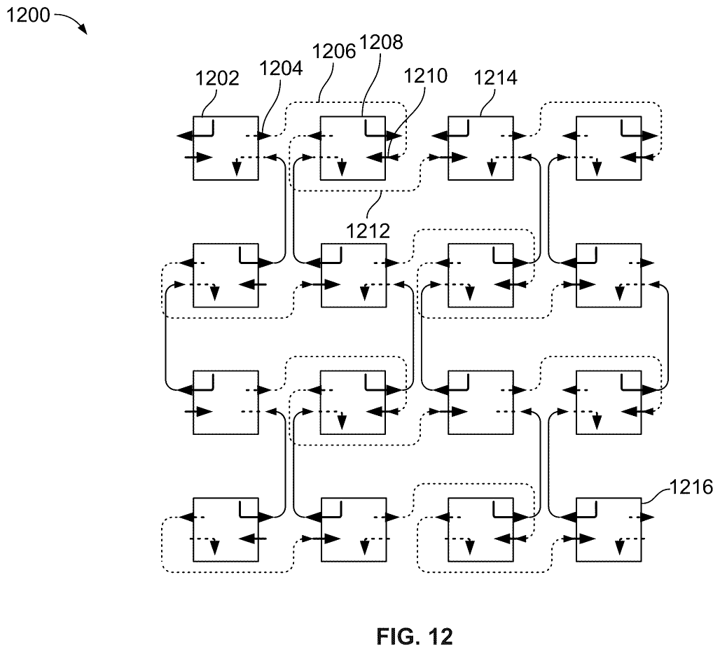

FIG. 12 depicts an example data flow of a compute cluster system 1200 including a plurality of compute accelerators (e.g., any of devices 1202, 1208, 1214, 1216), in accordance with some embodiments of this disclosure. FIG. 12 shows an example routing configuration for a cluster topology. In some embodiments, data may be routed in the system 1200 based on a mirror-image organization. For example, the mirror-image organization enables data to enter and exit through interfaces at corresponding sides of mirror-imaged compute accelerators, reducing (e.g., minimizing) communication latency. For example, the same routing configuration may be applied to each compute accelerator such that the data is routed in each compute accelerator in a similar manner as described with respect to FIG. 11. In some embodiments, the data is transmitted at a first interface at a respective side of a first compute accelerator (e.g., at point 1118 of FIG. 11) and is received at a second interface at a corresponding side of a second compute accelerator (e.g., at point 1116 of FIG. 11).

As an illustrative example, a packet may be transmitted from device 1202 using a port 1204. The port 1204 may be at a right side of the device 1202. In a mirror image of the device 1202, a corresponding port may be positioned at the left side if the layout is mirrored left-to-right. For example, a layout of device 1208 may be flipped such that the layout of device 1208 mirrors the device 1202 (e.g., a left-side port of device 1208 corresponds to the port 1204 of device 1202). For example, a layout of device 1214 may be a mirror image of the layout of device 1208 and the same layout as device 1202.

Continuing the illustrative example, the packet is transmitted from port 1204 to a port 1210 of the device 1208 using a communication path 1206 (e.g., a network link between the device 1202 and device 1208). The port 1210 may be positioned at a right edge of the device 1208. The packet may be routed by circuitry of the device 1208 (e.g., by corresponding PEs) following the routing configuration as described with respect to FIG. 11. The packet may be transmitted from the device 1208 using a port at a left edge of the device 1208 that corresponds to the port 1204 of the device 1202. The packet is transmitted to a device 1214 using a communication path 1212 (e.g., a network link between device 1208 and device 1214). The communication pattern may be repeated through each compute accelerator of the system 1200 (e.g., from device 1202 to device 1216 of FIG. 12 in this example), enabling each compute node of the cluster to perform respective computations based on a mapped model (e.g., mapped subdomains or model layers as described with respect to FIG. 1).

In some embodiments, a periodic data filter on node transmit is included and coupled with data replication upon receive. In some embodiments, a compute cluster may include vertical and/or horizontal communication channels, each with substantially the same number of network links between compute nodes.

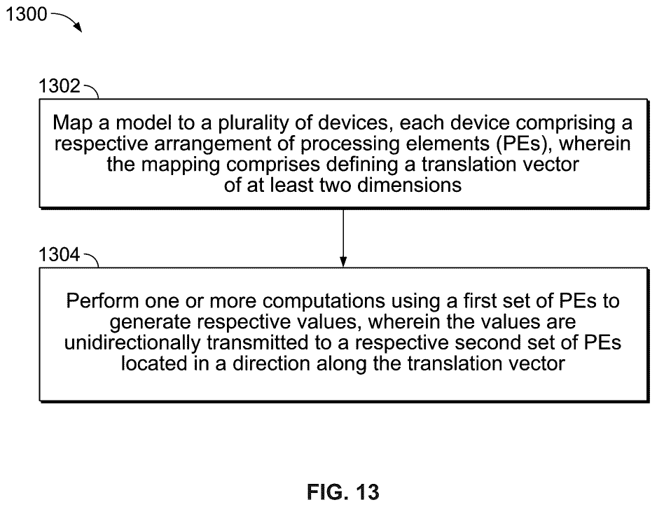

FIG. 13 is a flowchart of an example process 1300 including mapping a model to a plurality of devices and transmitting data from a first set of PEs to a respective second set of PEs located along a translation vector, in accordance with some embodiments of this disclosure. At block 1302, a model is mapped to a plurality of devices. Each device includes a respective arrangement of PEs. Mapping the model may include defining a translation vector of at least two dimensions having nonzero values. At block 1304, one or more computations may be performed using a first set of PEs to generate respective values. The values may be unidirectionally transmitted to a respective second set of PEs located in a direction along the translation vector. In some embodiments, the plurality of devices is configured to perform one or more computations using a first set of PEs of the plurality of devices based on the model to generate respective values and unidirectionally transmit the values to a respective second set of PEs for performing subsequent computations, wherein the respective second set of PEs is located in a direction along the translation vector. For example, the plurality of devices may be configured to automatically transmit the values to the respective second set of PEs based on the translation vector.

As an illustrative example, a plurality of devices may be arranged as a grid with a device at each grid point. It is noted that a grid arrangement is described for illustrative, non-limiting purposes and that the devices may be in any suitable arrangement in the principles set forth in the present disclosure. For example, the devices may be physically arranged in a stack (e.g., as described regarding the system 1000 of FIG. 10), and the connection topology and/or dataflow corresponds to a grid layout (e.g., as described regarding the system 300 of FIG. 3 or the system 1200 of FIG. 12).

In this example, a direction of translation may be defined as at least one grid point in each of the X and Y directions. Computations associated with a model (e.g., a parallelizable set of computations) are distributed among the plurality of devices. For example, computations associated with a plurality of subdomains may be mapped to the plurality of devices. For example, computations associated with a neural network model, and model layers thereof, may be mapped to the plurality of devices. Respective computations may be concurrently performed by the devices to generate respective datasets during a first step of a sequence. A first dataset from a first device may be transmitted to one or more devices using a network link for computations during one or more subsequent steps of the sequence. In this example, the one or more devices, or processors thereof, may be located diagonally from the first device (e.g., at least one grid point in each of the X and Y directions). The first dataset may be processed by the one or more devices to generate respective second datasets during a second step and transmitted to the next set of devices and respective processors located along the direction of translation. In this manner, the data follows a routing pattern analogous to the dataflow described regarding system 200 of FIG. 2. In some embodiments, the sequence may be arranged to occur within an increment of a counter indicative of a number of time steps or iterations.

The methods, systems, apparatuses, etc., discussed herein are intended to be illustrative and non-limiting. One skilled in the art would appreciate that the parts of the methods, systems, apparatuses, etc., discussed herein may be omitted, modified, combined, and/or rearranged, and any additional parts may be included, and/or any additional steps may be performed without departing from the scope of the present disclosure. More generally, the above disclosure is meant to be illustrative and not limiting. Only the claims that follow are meant to set bounds as to what the present disclosure includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. It should also be noted that the systems and/or methods described above may be applied to, or used in accordance with, other systems and/or methods. Throughout the specification the phrases “in response to,” “based on,” and “based at least in part on” shall be understood to have a broad meaning unless context requires otherwise. For example, “in response to” can refer to a step that is in direct or indirect response to a prior step, and “based on” can refer to a step that is based at least in part on a prior step.

What is claimed is:

1. A method for configuring a plurality of devices for performing computations, each device of the plurality of devices comprising a respective arrangement of processing elements (PEs), the method comprising:
mapping a model to the plurality of devices, wherein:
mapping the model comprises defining a translation vector of at least two dimensions, wherein each component of the translation vector is a nonzero value; and
the plurality of devices is configured to:
perform one or more computations using a first set of PEs of the plurality of devices based on the model to generate respective values; and
unidirectionally transmit the values to a respective second set of PEs for performing subsequent computations, wherein the respective second set of PEs is located in a direction along the translation vector.

2. The method of claim 1, further comprising performing the computations using the plurality of devices based on the mapping.

3. The method of claim 1, wherein one or both of the first set of PEs and the second set of PEs comprise one or more first PEs of a first device of the plurality of devices and one or more second PEs of a second device of the plurality of devices.

4. The method of claim 1, wherein the plurality of devices is further configured such that each PE of the first set of PEs transmits the respective values using one or more respective communication ports associated with the direction, and such that each PE of the second set of PEs receives the respective values using one or more respective communication ports associated with the direction.

5. The method of claim 1, wherein the plurality of devices is further configured such that the values are transmitted along a first component of the translation vector during a step of a sequence, and wherein the values are transmitted along a second component of the translation vector during a subsequent step of the sequence.

6. The method of claim 1, wherein mapping the model comprises defining a plurality of subdomains based on a computational grid, and wherein the one or more computations are associated with a respective subdomain of the plurality of subdomains.

7. The method of claim 1, wherein the model comprises a neural network model, wherein the neural network model comprises a plurality of nodes, and wherein the plurality of devices is further configured such that the values are unidirectionally transmitted to the respective second set of PEs mapped to respective nodes of the plurality of nodes.

8. The method of claim 1, wherein the first set of PEs is associated with a first device of the plurality of devices, wherein the first device is coupled to one or more second devices using one or more network links, and wherein the first device is configured to unidirectionally transmit the respective values using the one or more network links.

9. The method of claim 1, further comprising remapping the model to the plurality of devices, wherein respective operations associated with at least one first PE of the first set of PEs are remapped to at least one second PE of the respective second set of PEs located in the direction along the translation vector.

10. The method of claim 1, wherein the plurality of devices comprises one or more large-chip devices, and wherein each large-chip device of the one or more large-chip devices comprises a respective plurality of PEs arranged on a respective substrate of the large-chip device.

11. A system comprising:
a plurality of devices, each device of the plurality of devices comprising a respective arrangement of processing elements (PEs); and
processing circuitry configured to map a model to the plurality of devices, wherein:
the processing circuitry, when mapping the model to the plurality of devices, is configured to define a translation vector of at least two dimensions, wherein each component of the translation vector is a nonzero value; and
the plurality of devices is configured to:
perform one or more computations using a first set of PEs of the plurality of devices based on the model to generate respective values; and
unidirectionally transmit the values to a respective second set of PEs for performing subsequent computations, wherein the respective second set of PEs is located in a direction along the translation vector.

12. The system of claim 11, wherein the processing circuitry is further configured to perform the computations using the plurality of devices based on the mapping.

13. The system of claim 11, wherein one or both of the first set of PEs and the second set of PEs comprise one or more first PEs of a first device of the plurality of devices and one or more second PEs of a second device of the plurality of devices.

14. The system of claim 11, wherein the plurality of devices is further configured such that each PE of the first set of PEs transmits the respective values using one or more respective communication ports associated with the direction, and such that each PE of the second set of PEs receives the respective values using one or more respective communication ports associated with the direction.

15. The system of claim 11, wherein the plurality of devices is further configured such that the values are transmitted along a first component of the translation vector during a step of a sequence, and wherein the values are transmitted along a second component of the translation vector during a subsequent step of the sequence.

16. The system of claim 11, wherein the processing circuitry, when mapping the model, is configured to define a plurality of subdomains based on a computational grid, and wherein the one or more computations are associated with a respective subdomain of the plurality of subdomains.

17. The system of claim 11, wherein the model comprises a neural network model, wherein the neural network model comprises a plurality of nodes, and wherein the plurality of devices is further configured such that the values are unidirectionally transmitted to the respective second set of PEs mapped to respective nodes of the plurality of nodes.

18. The system of claim 11, wherein the first set of PEs is associated with a first device of the plurality of devices, wherein the first device is coupled to one or more second devices using one or more network links, and wherein the first device is configured to unidirectionally transmit the respective values using the one or more network links.

19. The system of claim 11, wherein the processing circuitry is further configured to remap the model to the plurality of devices, wherein respective operations associated with at least one first PE of the first set of PEs are remapped to at least one second PE of the respective second set of PEs located in the direction along the translation vector.

20. The system of claim 11, wherein the plurality of devices comprises one or more large-chip devices, and wherein each large-chip device of the one or more large-chip devices comprises a respective plurality of PEs arranged on a respective substrate of the large-chip device.
